(19) United States
(12) Patent Application Publication
(10) Pub. No.: US 2026/0061806 A1
(43) Pub. Date: Mar. 5, 2026

(54) CATCHER BRACKET FOR INTRUSION BEAM OF VEHICLE DOOR

(71) Applicant: Atieva, Inc., Newark, CA (US)

(72) Inventors: Brennan Williams, Newark, CA (US); Sriram Srinivasan, Newark, CA (US); Vivek Attaluri, Fremont, CA (US); Michal Tomczuk, Lublin (PL); Zachary Mark Walker, Mountain View, CA (US)

(21) Appl. No.: 18/819,859

(22) Filed: Aug. 29, 2024

(51) Int. Cl. B60J 5/04; B62D 25/04

(52) U.S. Cl. CPC B60J 5/0443; B60J 5/0413; B60J 5/0415; B62D 25/04

(57) ABSTRACT

A vehicle door for a vehicle comprises: a door frame configured for being mounted to a vehicle body, the door frame comprising at least one door panel; an intrusion beam mounted across the door frame, the intrusion beam having a yield strength greater than the door panel; and a catcher bracket mounted to the intrusion beam and to the door panel, the catcher bracket comprising a hook that is configured to enter an opening in the vehicle body when the vehicle door is closed, and engage with the opening upon an impact on the vehicle door.

### TECHNICAL FIELD

This document relates to a catcher bracket for an intrusion beam of a vehicle door.

### BACKGROUND

Various approaches have been taken to improve a vehicle's resistance to side impacts. For example, some manufacturers choose to make the opening to the second row of seats relatively narrow, meaning that the body-in-white opening is narrower (i.e., there is less separation between the B-pillar and the C-pillar) on each side of the vehicle. This closeness can increase the chance that the B-pillar or the C-pillar will be impacted and carry at least part of the load path of the side impact. However, the relatively narrow door opening makes ingress and egress more challenging. Some attempts have been made to create an engagement between the edge of the door and the body, but these efforts appear to be directed toward reducing the intrusion of the base of the door frame. Other vehicles may be designed so that a typical side impact has some overlap with the sill, but this results from the vehicle having a greater ride height than most passenger vehicles.

### SUMMARY

In a first aspect, a vehicle door for a vehicle comprises: a door frame configured for being mounted to a vehicle body, the door frame comprising at least one door panel; an intrusion beam mounted across the door frame, the intrusion beam having a yield strength greater than the door panel; and a catcher bracket mounted to the intrusion beam and to the door panel, the catcher bracket comprising a hook that is configured to enter an opening in the vehicle body when the vehicle door is closed, and engage with the opening upon an impact on the vehicle door.

Implementations can include any or all of the following features. The catcher bracket comprises: a first portion configured to extend substantially in parallel with the intrusion beam; a second portion extending substantially perpendicular from an end of the first portion; and a lip extending at an angle from a distal end of the second portion, wherein at least the second portion and the lip form the hook. The vehicle door further comprises an undercut in the lip inside the hook. The undercut is formed by a rounded cutout made in the lip. The vehicle door further comprises a reinforcement between the first portion and the second portion, the reinforcement positioned at the end of the first portion. The reinforcement faces the hook. The reinforcement is positioned on an opposite side of the catcher bracket from the hook. The catcher bracket is mounted by at least one bolt to a first end of the intrusion beam and to a first portion of the door panel. The catcher bracket and the intrusion beam and the door panel form a stack, wherein the catcher bracket is innermost in the stack, wherein the intrusion beam is outermost in the stack, and wherein the door panel is positioned between the catcher bracket and the intrusion beam in the stack. A second end of the intrusion beam opposite from the first end is mounted to a second portion of the door panel by at least one bolt. The second portion of the door panel is positioned higher on the vehicle door than is the first portion of the door panel. The door panel is a door inner panel configured to be positioned toward an interior of the vehicle, the vehicle door further comprising a door outer panel configured to be positioned on an opposite side of the door inner panel from the interior of the vehicle. The catcher bracket is made of forged steel. The intrusion beam is made of steel. The intrusion beam is hot stamped from a steel material. The door panel comprises a stamped door panel. The stamped door panel is made of aluminum or an aluminum composite.

In a second aspect, a vehicle comprises: a vehicle body including a pillar and a door opening; and a vehicle door to provide ingress and egress for the door opening, the vehicle door comprising: a door frame configured for being mounted to the vehicle body, the door frame comprising at least one door panel; an intrusion beam mounted across the door frame, the intrusion beam having a yield strength greater than the door panel; and a catcher bracket mounted to the intrusion beam and to the door panel, the catcher bracket comprising a hook that enters a first opening in the pillar when the vehicle door is closed and engages with the first opening upon an impact on the vehicle door.

Implementations can include any or all of the following features. The vehicle further comprises a reinforcement panel positioned on the pillar, reinforcement panel the having a second opening substantially aligned with the first opening, wherein the hook enters the first and second openings when the vehicle door is closed and engages with the first and second openings upon the impact on the vehicle door. The vehicle further comprises a cup positioned in the first opening so that an interior of the cup receives the hook when the vehicle door is closed. The pillar is a C-pillar of the vehicle. Only a corner of the intrusion beam overlaps with the pillar.

In a third aspect, a catcher bracket for a door of a vehicle comprises: a first portion that is substantially planar, the first portion configured to extend substantially in parallel with an intrusion beam of the door when the catcher bracket is mounted to the intrusion beam; a second portion that is substantially planar and extends substantially perpendicular to the first portion from an end of the first portion; and a lip extending at an angle to the second portion from a distal end of the second portion, wherein at least the second portion and the lip form a hook that is configured for engaging with an opening of a body of the vehicle.

### BRIEF DESCRIPTION OF DRAWINGS

FIG. 1 shows an example of a catcher bracket for a vehicle door.

FIG. 2 shows an example side view of the catcher bracket of FIG. 1.

FIG. 3 shows an example of a vehicle.

FIG. 4 shows an example of a vehicle door.

FIG. 5 schematically shows the intrusion beam of FIG. 4 positioned in relation to a vehicle body.

FIG. 6 shows an example of the catcher bracket of FIG. 1 positioned in relation to an opening having a reinforcement.

FIG. 7 shows an example section showing the catcher bracket of FIG. 1 and a base of a pillar of a vehicle body when a vehicle door is closed.

Like reference symbols in the various drawings indicate like elements.

### DETAILED DESCRIPTION

This document describes examples of systems and techniques for providing a catcher bracket to be mounted on an intrusion beam of a vehicle door. The catcher bracket can facilitate that the intrusion beam engages with a portion of the vehicle body upon impact, thereby facilitating the intrusion beam resisting intrusion of the door. Such catcher bracket(s) can be particularly advantageous in vehicles that have a relatively wider door opening, because the intrusion beam may have little or no overlap with any pillar of the vehicle body, which could otherwise provide a load path. As such, a catcher bracket that engages with a pillar of the body can act as an additional load path during impact and thereby help the intrusion beam absorb more of the impact energy. For example, this can reduce the load of other aspects of the vehicle door, such as the striker and latch. That is, the catcher bracket can provide that the intrusion beam is put into tension, rather than simply being bent, upon impact. For example, the catcher bracket can be said to effectively lock the intrusion beam and put it into tension. As such, using a catcher bracket according to the present disclosure can allow a vehicle designer to provide a wider door opening, thereby improving the ingress and egress from the passenger compartment.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle.

Examples described herein refer to an intrusion beam. As used herein, an intrusion beam is a member mounted across a door frame of a vehicle to reinforce the door against impact. The intrusion beam can be made of the same or a different material than the door frame. The intrusion beam can have the same or a different thickness than a door panel of the door frame. For example, the intrusion beam can be made (e.g., hot stamped) using metal stock (e.g., ultra high strength steel) having a greater thickness than the door panel(s). As another example, the intrusion beam can instead or also have a geometry (e.g., a corrugation or other profile or another strengthening shape) to facilitate the intrusion beam resisting door deformation during impact.

Examples described herein refer to a catcher bracket. As used herein, a catcher bracket is a member attached to an intrusion beam of a vehicle door to facilitate that the intrusion beam can engage with a portion of the vehicle body when the vehicle door is closed. The catcher bracket can be designed to fit inside an opening in the vehicle body (e.g., at a base of a pillar thereof) when the door is closed, so that an impact on the door causes tension in the intrusion beam, thereby resisting inward deformation of the door.

Examples described herein refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

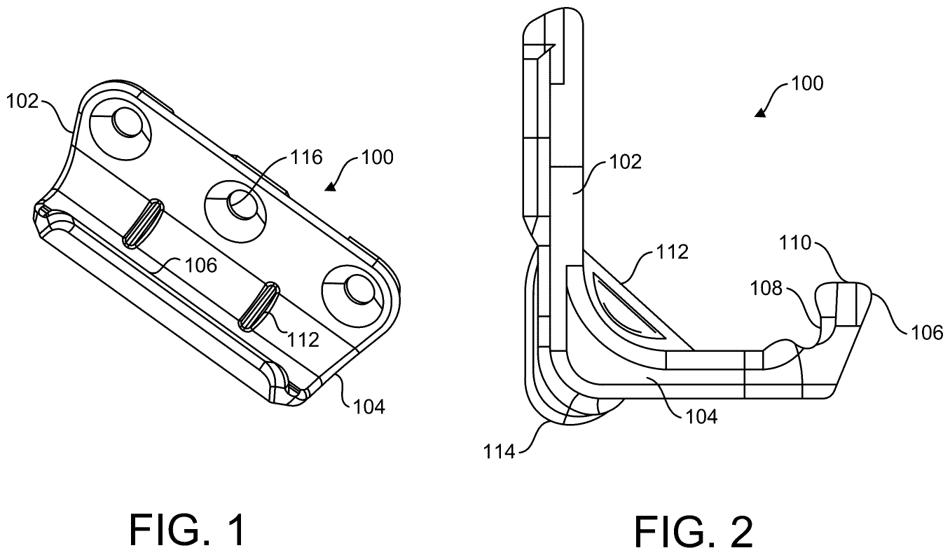

FIG. 1 shows an example of a catcher bracket 100 for a vehicle door. FIG. 2 shows an example side view of the catcher bracket 100 of FIG. 1. The catcher bracket 100 can be used with one or more other examples described elsewhere herein.

The catcher bracket 100 can be made of any material that gives the catcher bracket 100 significant yield strength. The catcher bracket 100 can be forged using metal. In some implementations, the catcher bracket 100 includes forged steel. For example, the catcher bracket 100 can be a forged part that is then machined using a computer numerical control (CNC) machine. For example, post-machining CNC operations can be performed to form the geometry of the catcher bracket 100.

The catcher bracket 100 comprises a hook. The hook can be formed substantially as follows. The catcher bracket 100 can include a portion 102 that can be substantially planar. For example, the portion 102 can be configured to extend substantially in parallel with the intrusion beam (described below) when the catcher bracket 100 is mounted to the intrusion beam. The catcher bracket 100 can include a portion 104 that can be substantially planar. For example, the portion 104 can be configured to extend substantially perpendicular from an end of the portion 102. The catcher bracket 100 can include a lip 106 extending at an angle from a distal end of the portion 104. At least the portion 104 and the lip 106 can form the hook of the catcher bracket 100. For example, a profile of the catcher bracket 100 can be substantially L-shaped.

The catcher bracket 100 can have an undercut to facilitate engagement with an opening in the vehicle body when the vehicle door is closed. The undercut can be formed by making a portion 108 of the lip 106 a narrower dimension (e.g., as viewed in FIG. 2) than an end 110 of the lip 106, wherein the portion 108 is positioned proximate to the end 110 and oriented inside the hook (i.e., facing inward). The undercut can be formed in any of multiple ways including but not limited to by deformation or by machining a rounded cutout (e.g., as illustrated) at the portion 108.

The catcher bracket 100 can include one or more reinforcements. In some implementations, the reinforcement(s) can be formed between the portion 102 and the portion 104, positioned at the end of the portion 102 from which the portion 104 extends. For example, a reinforcement 112 faces the hook. As another example, a reinforcement 114 is positioned on an opposite side of the catcher bracket 100 from the hook. Other approaches can be used.

The catcher bracket 100 can include one or more openings 116 for a fastener to mount the catcher bracket 100 to the intrusion beam. Here, the catcher bracket 100 includes three openings positioned in a linear configuration across the portion 102. More or fewer openings can be used.

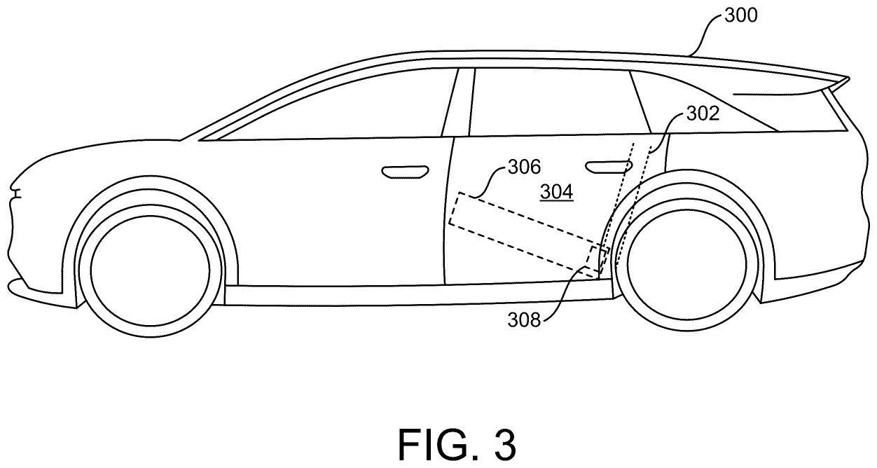

FIG. 3 shows an example of a vehicle 300 with which the catcher bracket 100 of FIG. 1 can be used. The vehicle 300 includes a vehicle body that defines the shape of the vehicle 300 and forms the structural support for all components thereof. The vehicle body can include a C-pillar 302 on each side. The C-pillar 302 is here partially shown and schematically illustrated in phantom. Respective instances of the C-pillar 302 can be situated on the left and right sides of the vehicle 300. A door 304 provides ingress and egress to a second row of seats of the vehicle 300 (and optionally also to at least one seat rear of the second row). The door 304 can be structured using a door frame made from one or more door panels. A component of the door 304 is an intrusion beam 306 (here schematically illustrated) that is mounted across the door frame to add reinforcement against side impact. A catcher bracket 308 (here schematically illustrated) is mounted to the intrusion beam 306 to anchor the intrusion beam 306 to the vehicle body when the door 304 is closed. For example, the catcher bracket 100 (FIG. 1) can be used as the catcher bracket 308.

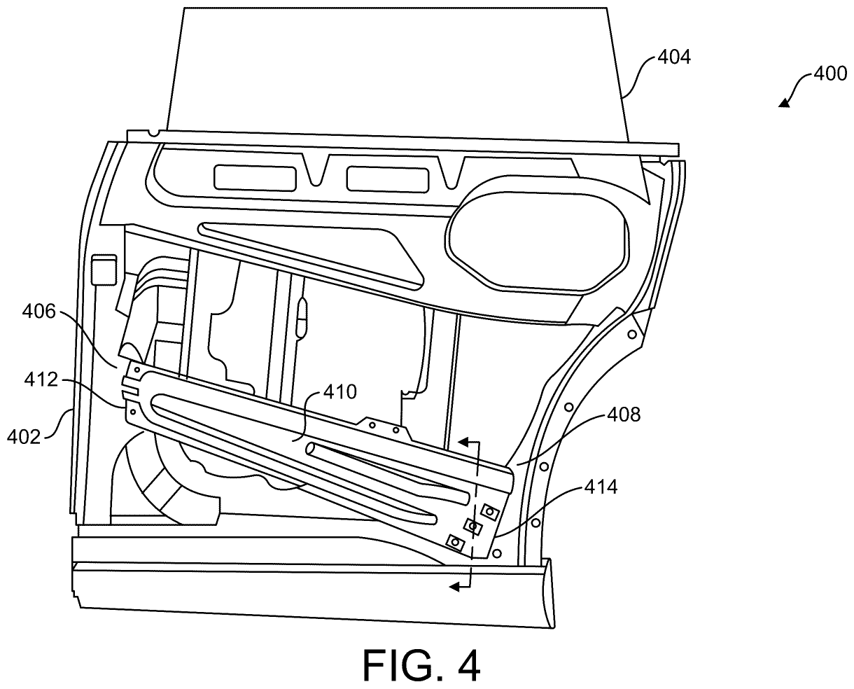

FIG. 4 shows an example of a vehicle door 400. The vehicle door 400 can be used with one or more other examples described elsewhere herein. The vehicle door 400 is here shown from the outside and can be installed on a side of the vehicle using one or more hinges (e.g., with a corresponding other instance of the vehicle door 400 installed on the other side). The vehicle door 400 can be a door for a second row of seats in the vehicle, or for any other seat row.

The vehicle door 400 is structured by a door frame 402 that is configured to support at least one window pane 404. The window pane 404 can be fixed to the vehicle door 400 or can be movable between at least two positions (e.g., using a window elevator mounted to the door frame 402). A door outer panel that faces outward when the vehicle door 400 is installed is here omitted to show the inside of the vehicle door 400.

The door frame 402 can comprise at least one door panel. In some implementations, the door panel can be a stamped door panel. For example, the door panel can be formed substantially from aluminum or an aluminum composite. Here, the door frame 402 includes a door panel 406 and a door panel 408, to name just two examples.

The vehicle door 400 includes an intrusion beam 410 mounted across the door frame 402. The intrusion beam 410 is designed to increase the resistance of the vehicle door 400 against intrusion in a side impact of the vehicle. The intrusion beam 410 can be made of one or more materials that give the intrusion beam 410 a yield strength greater than the door panel(s) of the 402. In some implementations, the intrusion beam 410 is made of ultra high strength steel. The intrusion beam 410 can be formed by hot stamping of metal stock. For example, the intrusion beam 410 can have a profile (e.g., one or more corrugations or other shapes) that increases its ability to resist intrusion. That is, the intrusion beam 410 has mechanical properties so as to be difficult to plastically deform due to a high yield strength.

The intrusion beam 410 has an end 412 that is mounted to the door panel 406. For example, one or more fasteners (e.g., bolts) extending through the end 412 can be used. The intrusion beam 410 has an end 414 opposite the end 412 that is mounted to the door panel 408. For example, one or more fasteners (e.g., bolts) extending through the end 414 can be used. In some implementations, the fastener(s) at the end 414 can serve both to mount the intrusion beam 410 to the door panel 408 and to mount the catcher bracket to the intrusion beam 410 and to the door panel 408. The end 412 can be positioned higher on the vehicle door 400 than is the end 414. This positioning can ensure that the intrusion beam 410 extends across a sufficient part of the door frame 402. For example, this can orient the intrusion beam 410 across an area that is more likely to sustain impact in a side collision.

The above examples illustrate that a vehicle door (e.g., the vehicle door 400) for a vehicle (e.g., for the vehicle 300 in FIG. 3) can include: a door frame (e.g., the door frame 402) configured for being mounted to a vehicle body (e.g., of the vehicle 300 in FIG. 3), the door frame comprising at least one door panel (e.g., the door panel 406 or door panel 408); an intrusion beam (e.g., the intrusion beam 410) mounted across the door frame, the intrusion beam having a yield strength greater than the door panel; and a catcher bracket (e.g., the catcher bracket 100 of FIG. 1) mounted to the intrusion beam and to the door panel. Examples described below illustrate that the catcher bracket can include a hook that is configured to enter an opening in the vehicle body when the vehicle door is closed. This can facilitate that the catcher bracket engages with the opening upon an impact on the vehicle door.

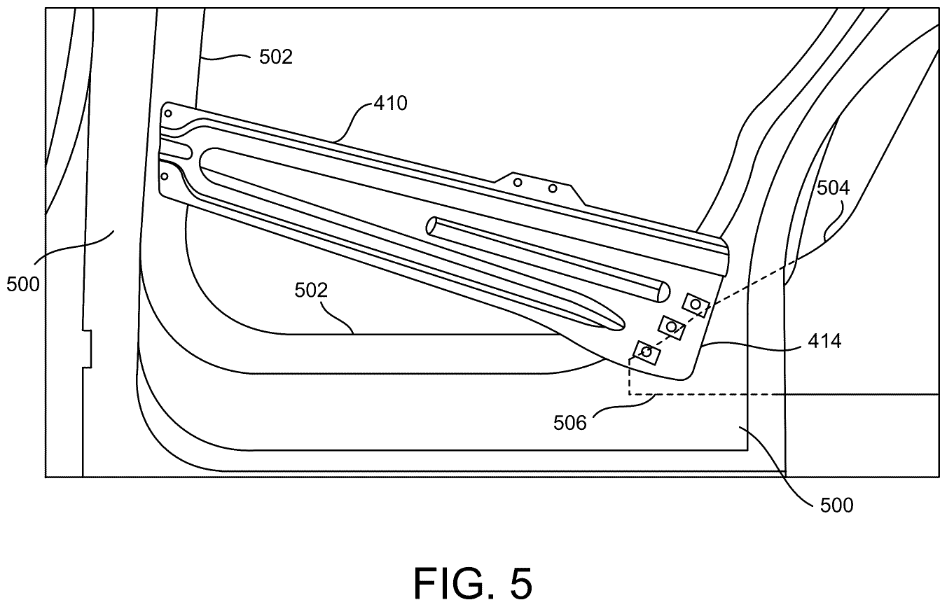

FIG. 5 schematically shows the intrusion beam 410 of FIG. 4 positioned in relation to a vehicle body 500. The vehicle body 500 is here only partially shown for clarity. Particularly, the vehicle body 500 provides ingress and egress by a door opening 502 to which a door such as the vehicle door 400 in FIG. 4 can be mounted. That is, the intrusion beam 410 is here schematically illustrated, without the rest of the door being visible, to exemplify a position of the intrusion beam 410 in relation to the vehicle body 500. The vehicle body 500 can have one or more pillars. In some implementations, the vehicle body 500 can have at least an A-pillar, a B-pillar and a C-pillar on each side of the vehicle. For example, a pillar 504 of the vehicle body 500 can be a C-pillar of the vehicle. A base of the pillar 504 is obscured by a part of the vehicle body 500 and a portion 506 of the base is therefore here shown in phantom.

One advantage of using a catcher bracket according to the present disclosure is that intrusion resistance by the intrusion beam 410 can be improved when the door opening 502 is relatively wide. When the opening is wider, there can be less overlap between the intrusion beam 410 and the base of the pillar 504. Here, the end 414 of the intrusion beam 410 has relatively little overlap with the base of the pillar 504. For example, only a corner of the intrusion beam 410 overlaps with the pillar 504, the corner overlapping with a part of the portion 506.

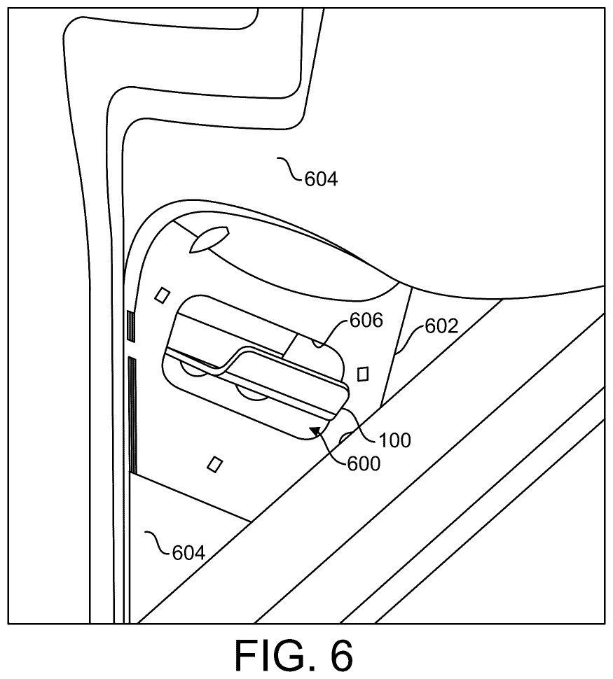

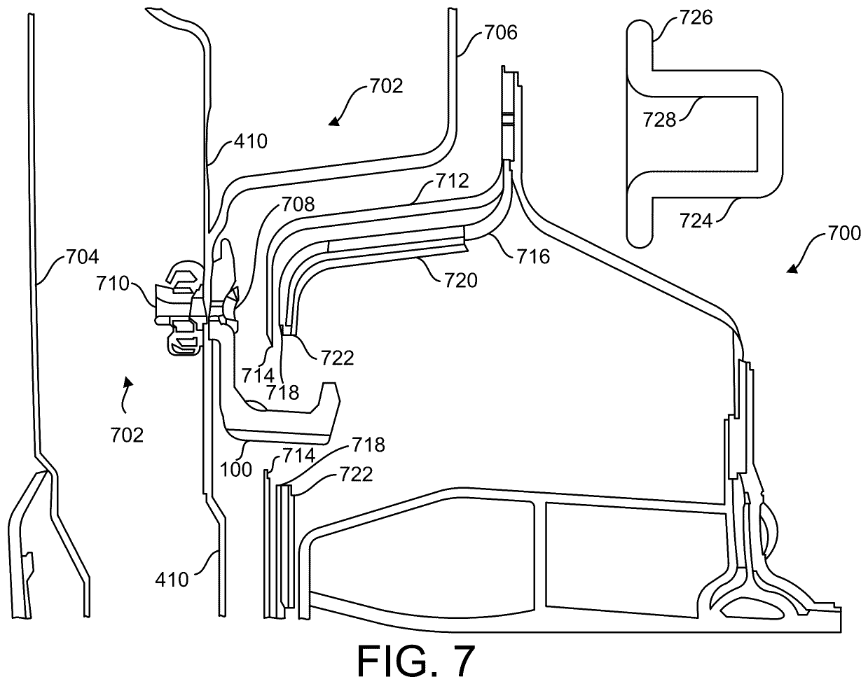

FIG. 6 shows an example of the catcher bracket 100 of FIG. 1 positioned in relation to an opening 600 having a reinforcement 602. That is, one or more body panels 604 can in part form a pillar base. The one or more body panels 604 can define an opening through which the hook of the catcher bracket 100 can extend when the vehicle door is closed. The reinforcement 602 can be an additional panel (smaller than the body panels) through which an opening 606 is formed. For example, the reinforcement 602 can be a sheet metal part or a casting. The opening 606 of the reinforcement 602 can be aligned with the opening of the one or more body panels 604 to form the opening 600 that accommodates the hook. During a side impact, force can be applied to the intrusion beam so that the hook of the catcher bracket 100 engages with (e.g., grabs or otherwise hooks to) the opening 600. This allows tension to be built up in the intrusion beam, rather than the intrusion beam merely being bent by the impact.

FIG. 7 shows an example section showing the catcher bracket 100 of FIG. 1 and a base 700 of a pillar of a vehicle body when a vehicle door 702 is closed. Only a portion of the vehicle door 702 is shown for clarity. The shown section approximately corresponds to a section taken at the line shown in FIG. 4, with some exceptions mentioned below.

The vehicle door 702 can be formed of multiple door panels. Here, the vehicle door 702 includes a door outer panel 704 and a door inner panel 706. That is, the door outer panel 704 is visible in this section although the door outer panel was omitted in FIG. 4. The door inner panel 706 is configured to be positioned toward an interior of the vehicle. Th door outer panel 704 is configured to be positioned on an opposite side of the door inner panel 706 from the interior of the vehicle.

The vehicle door 702 here includes the intrusion beam 410. The intrusion beam 410 is positioned between the door outer panel 704 and the door inner panel 706 in the vehicle door 702. The catcher bracket 100 and the intrusion beam 410 and the door inner panel 706 form a stack in the region where the catcher bracket 100 is attached. For example, at least one bolt 708 can extend though coaxial openings in the stack and be secured at an end 710 extending at an opposite side of the stack, or vice versa. Here, the catcher bracket 100 is innermost in the stack (i.e., closest to the passenger compartment of the stack layers when the vehicle door 702 is closed). The intrusion beam 410 is outermost in the stack, and the door inner panel 706 is positioned between the catcher bracket 100 and the intrusion beam 410 in the stack. With reference again briefly also to FIG. 5, the catcher bracket 100 can be mounted to the intrusion beam 410 and the door inner panel 706 at the end 414 of the intrusion beam 410.

The base 700 can be the base of any pillar, including but not limited to a C-pillar of the vehicle. For example, the base 700 can terminate at a position where the base 700 meets a rocker panel of the vehicle body. The base 700 can include a body side outer panel 712 that defines an opening 714. The base 700 can include a door ring outer panel 716 that defines an opening 718. The base 700 can include a reinforcement panel 720 that defines an opening 722. The openings 714, 718 and 722 are substantially aligned with each other (e.g., coaxial). As such, the openings 714, 718 and 722 accommodate entry by the hook of the catcher bracket 100. Upon a side impact, the hook of the catcher bracket 100 can engage with one or more (e.g., all) of the openings 714, 718 and 722.

The above examples illustrate that a vehicle (e.g., the vehicle 300 in FIG. 3) can include: a vehicle body (e.g., the vehicle body 500 in FIG. 5) including a pillar (e.g., the pillar 504 in FIG. 5) and a door opening (e.g., the door opening 502 in FIG. 5); and a vehicle door (e.g., the vehicle door 400 in FIG. 4) to provide ingress and egress for the door opening. The vehicle door can include: a door frame (e.g., the door frame 402) configured for being mounted to the vehicle body, the door frame comprising at least one door panel (e.g., the door panel 406 or door panel 408); an intrusion beam (e.g., the intrusion beam 410) mounted across the door frame, the intrusion beam having a yield strength greater than the door panel; and a catcher bracket (e.g., the catcher bracket 100 of FIG. 1) mounted to the intrusion beam and to the door panel, the catcher bracket comprising a hook that enters a first opening in the pillar (e.g., the opening 600 in FIG. 6) when the vehicle door is closed and engages with the first opening upon an impact on the vehicle door.

The openings 714, 718 and 722 can be protected against precipitation, dust, debris, etc., entering into the interior of the base 700. In some implementations, a cup 724 is designed to fit within the openings 714, 718 and 722. The cup 724 is here likewise shown in section, and is illustrated separate from the openings 714, 718 and 722 for clarity. When the cup 724 is installed at the openings 714, 718 and 722, a lip 726 of the cup 724 can fit against the outside of the body side outer panel 712 around the periphery of the opening 714. An interior 728 of the cup 724 can receive the hook of the catcher bracket 100 when the vehicle door 702 is closed. The cup 724 can be made of any sealing material. For example, the cup 724 can be made of rubber or another deformable material. That is, when the hook of the catcher bracket 100 engages with one or more (e.g., all) of the openings 714, 718 and 722, this engagement can occur through the wall of the cup 724.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A vehicle door for a vehicle, the vehicle door comprising:
a door frame configured for being mounted to a vehicle body, the door frame comprising at least one door panel;
an intrusion beam mounted across the door frame, the intrusion beam having a yield strength greater than the door panel; and
a catcher bracket mounted to the intrusion beam and to the door panel, the catcher bracket comprising a hook that is configured to enter an opening in the vehicle body when the vehicle door is closed, and engage with the opening upon an impact on the vehicle door.

2. The vehicle door of claim 1, wherein the catcher bracket comprises:
a first portion configured to extend substantially in parallel with the intrusion beam;
a second portion extending substantially perpendicular from an end of the first portion; and
a lip extending at an angle from a distal end of the second portion, wherein at least the second portion and the lip form the hook.

3. The vehicle door of claim 2, further comprising an undercut in the lip inside the hook.

4. The vehicle door of claim 3, wherein the undercut is formed by a rounded cutout made in the lip.

5. The vehicle door of claim 2, further comprising a reinforcement between the first portion and the second portion, the reinforcement positioned at the end of the first portion.

6. The vehicle door of claim 5, wherein the reinforcement faces the hook.

7. The vehicle door of claim 5, wherein the reinforcement is positioned on an opposite side of the catcher bracket from the hook.

8. The vehicle door of claim 1, wherein the catcher bracket is mounted by at least one bolt to a first end of the intrusion beam and to a first portion of the door panel.

9. The vehicle door of claim 8, wherein the catcher bracket and the intrusion beam and the door panel form a stack, wherein the catcher bracket is innermost in the stack, wherein the intrusion beam is outermost in the stack, and wherein the door panel is positioned between the catcher bracket and the intrusion beam in the stack.

10. The vehicle door of claim 8, wherein a second end of the intrusion beam opposite from the first end is mounted to a second portion of the door panel by at least one bolt.

11. The vehicle door of claim 10, wherein the second portion of the door panel is positioned higher on the vehicle door than is the first portion of the door panel.

12. The vehicle door of claim 8, wherein the door panel is a door inner panel configured to be positioned toward an interior of the vehicle, the vehicle door further comprising a door outer panel configured to be positioned on an opposite side of the door inner panel from the interior of the vehicle.

13. The vehicle door of claim 1, wherein the catcher bracket is made of forged steel.

14. The vehicle door of claim 1, wherein the intrusion beam is made of steel.

15. The vehicle door of claim 14, wherein the intrusion beam is hot stamped from a steel material.

16. The vehicle door of claim 1, wherein the door panel comprises a stamped door panel.

17. The vehicle door of claim 16, wherein the stamped door panel is made of aluminum or an aluminum composite.

18. A vehicle comprising:
a vehicle body including a pillar and a door opening; and
a vehicle door to provide ingress and egress for the door opening, the vehicle door comprising:
a door frame configured for being mounted to the vehicle body, the door frame comprising at least one door panel;
an intrusion beam mounted across the door frame, the intrusion beam having a yield strength greater than the door panel; and
a catcher bracket mounted to the intrusion beam and to the door panel, the catcher bracket comprising a hook that enters a first opening in the pillar when the vehicle door is closed and engages with the first opening upon an impact on the vehicle door.

19. The vehicle of claim 18, further comprising a reinforcement panel positioned on the pillar, reinforcement panel the having a second opening substantially aligned with the first opening, wherein the hook enters the first and second openings when the vehicle door is closed and engages with the first and second openings upon the impact on the vehicle door.

20. (canceled)

21. (canceled)

22. (canceled)

23. A catcher bracket for a door of a vehicle, the catcher bracket comprising:
a first portion that is substantially planar, the first portion configured to extend substantially in parallel with an intrusion beam of the door when the catcher bracket is mounted to the intrusion beam;
a second portion that is substantially planar and extends substantially perpendicular to the first portion from an end of the first portion; and
a lip extending at an angle to the second portion from a distal end of the second portion, wherein at least the second portion and the lip form a hook that is configured for engaging with an opening of a body of the vehicle.
